(19) United States
(12) Patent Application Publication
(10) Pub. No.: US 2017/0282100 A1
(43) Pub. Date: Oct. 5, 2017

(54) Spiral seal continuous discharge filter for supercritical water treatment process

(71) Applicant: XI'AN JIAOTONG UNIVERSITY, Xi'an, Shaanxi (CN)

(72) Inventors: Shuzhong Wang, Xi'an (CN); Wenhan Song, Xi'an (CN); Laisheng Wang, Xi'an (CN); Yanhui Li, Xi'an (CN); Mengmeng Ren, Xi'an (CN); Panpan Sun, Xi'an (CN); Jianqiao Yang, Xi'an (CN); Jie Zhang, Xi'an (CN)

(73) Assignee: XI'AN JIAOTONG UNIVERSITY

(21) Appl. No.: 15/623,382

(22) Filed: Jun. 15, 2017

(51) Int. Cl. B01D 29/94; B01D 29/64; B01D 29/11

(52) U.S. Cl. CPC B01D 29/94; B01D 29/117; B01D 29/6415

(57) ABSTRACT

A spiral seal continuous discharge filter for supercritical water treatment process is provided, including: a filter chamber and a motor 1 provided on a top of the filter chamber; wherein a liquid inlet is provided on an up portion of a wall of the filter chamber, a filter screen is provided in the filter chamber, a purified liquid outlet is provided on an external side of the filter screen, a vertical discharge pipe is provided on a bottom portion of the filter chamber, a driving rod rotated by driven of the motor is provided on a central axis of the filter chamber, a plurality of electric scratch brushes are provided on the driving rod, and a two-stage spiral blade unit is provided on a bottom of the driving rod.

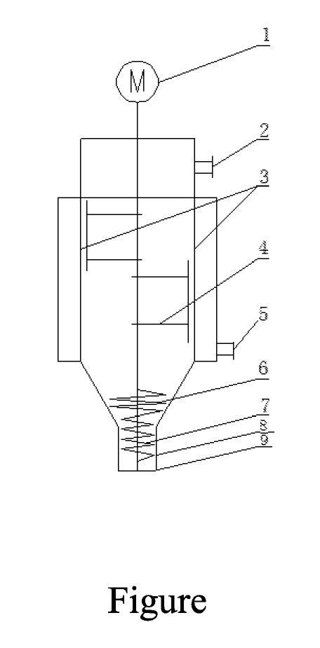

### BACKGROUND OF THE PRESENT INVENTION

### Field of Invention

The present invention relates to the field of filtering and separating technique, and more particularly to a spiral seal continuous discharge filter for supercritical water treatment process.

### Description of Related Arts

At present, continuous filters are widely applied in chemical production due to various advantages such as simple structure, high filter rating, capability of automatically washing the filter screen and PLC intelligent control discharge. With merits of sensitive response, safe application and low price, electromagnetic valves are widely applied as the discharging pipe switch of the conventional continuous filters. However, the electromagnetic valve has a poor reliability in the vertical discharging pipe and the service life of the electromagnetic valve is greatly shortened, so the discharging pipe in the conventional continuous filters is horizontally installed. The normal discharging process of the conventional continuous filters is as follows. Liquid filtered passes through a liquid inlet to enter internal part of the filter screen, and then passes through the filter screen from inside out; the filtered clear liquid passes through a clear liquid outlet to enter the follow-up process. Due to the screening action of the filter screen, the filter residue is accumulated on the internal wall of the filter screen. When the filter residue is accumulated to a certain amount on the internal wall of the filter screen, the monitor system monitors that the differential pressure reaches a cleaning differential pressure or determines that the cleaning time is up according to the preset time by the user, the PLC issues the instruction to start the electric scraper, the electric scraper starts to rotate, the filter residue on the internal wall of the filter screen is cleaned. Due to the gravity accumulation, the filter residue is accumulated to the inlet of the discharging electromagnetic valve. Meanwhile, PLC sends an instruction to the electromagnetic valve to open the electromagnetic valve and the materials are discharged taking advantage of the differential pressure between the filter and the outlet of the electromagnetic valve. However, the content amount of waste liquid or sludge by the supercritical water treatment process is generally high, and the content is still high after treatment. If plenty of slag is accumulated in the internal wall of the filter in a short time, the filter residue washed by the electric scratch brush is accumulated in the discharge pipe and the inlet terminal of the discharging solenoid valve, forming a more dense filter layer even a block. At this time even if the discharge solenoid valve switch is opened, the differential pressure between inside and outside of the filter is also very difficult to achieve a smooth discharging. The filter residue will accumulate more and more, affecting the normal operation of the filter, at this time the discharge pipe must be manually dredged to assist discharging. This way is a waste of time and labors. Furthermore, even a smooth discharge can be achieved, the intermittent discharge mode, which relies on pressure or time to automatically control the discharge, has the biggest drawback as follows. The pressure inside the filter chamber fluctuates during the discharging process, which in turn affects the pressure on the inlet pipe of the filter and causes pressure fluctuations of the whole system. Because during the discharging process, the chamber of the filter is communicated with the atmosphere by the discharge pipe and the discharge solenoid valve, with the discharging process, the pressure in the chamber of the filter gradually decreases; when the discharging process terminates, the discharge solenoid valve is closed, and the pressure in the chamber of the filter gradually increases, so the discharge valve constantly opened and closed, the pressure is not capable of maintaining stable, which inevitably affects the system security.

### SUMMARY OF THE PRESENT INVENTION

In order to overcome the drawbacks mentioned above in the conventional art, an object of the present invention is to provide a spiral seal continuous discharge filter for supercritical water treatment process, which has characteristics of rational design, easy operation and capability of achieving continuous non-blocking discharge, wherein the pressure inside the filter chamber is stable while discharging.

Technical solution of the present invention is as follows.

A spiral seal continuous discharge filter for supercritical water treatment process, comprises: a filter chamber and a motor 1 provided on a top of the filter chamber; wherein a liquid inlet is provided on an up portion of a wall of the filter chamber, a filter screen is provided in the filter chamber, a purified liquid outlet is provided on an external side of the filter screen, a vertical discharge pipe is provided on a bottom portion of the filter chamber, a driving rod rotated by driven of the motor is provided on a central axis of the filter chamber, a plurality of electric scratch brushes are provided on the driving rod, and a two-stage spiral blade unit is provided on a bottom of the driving rod.

Preferably, the two-stage spiral blade unit comprises from top to bottom mixing blades for mixing filter residue and a spiral blade for sealing and pushing the filter residue.

Preferably, the mixing blades for mixing the filter residue are provided in a tapering cavity on a bottom of the filter chamber; the spiral blade for sealing and pushing the filter residue is provided in the vertical discharge pipe.

Preferably, a distance between the spiral blade for sealing and pushing the filter residue and an internal wall of the vertical discharge pipe is 0.15-1 mm.

Preferably, a diameter of the mixing blades for mixing the filter residue is greater than a diameter of the spiral blade for sealing and pushing the filter residue.

Preferably, an amount of the mixing blades for mixing the filter residue is at a range of 6-8.

Preferably, an amount of the spiral blades for sealing and pushing the filter residue is at a range of 2-10.

Preferably, a discharge opening is welded on a bottom of the vertical discharge pipe

Compared with the conventional art, the present invention has beneficial effects as follows.

The present invention provides a spiral seal continuous discharge filter for supercritical water treatment process. A vertical discharge pipe is vertically provided below the discharge opening of the continuous filter, due to the gravity and pressure the filter residue in the discharge pipe is easier to be discharged than the filter residue in horizontally provided discharge pipe, which effectively solves the problem of the blocking in the continuous filter during the discharge while filtering high containing liquid. Meanwhile, a two-stage spiral blade unit is provided on a bottom of the driving rod, so as to stir, seal and push the filter residue layer. The two-stage spiral blade unit plays a corresponding role in different falling position of the discharging material, so as to ensure efficient discharge and meanwhile stabilize internal pressure of the filter chamber. The spiral seal continuous discharge filter designed by the present invention eliminates the arrangement of the discharge solenoid valve, which is capable of ensuring a smoother discharge, a stable pressure and a safe system. Thus, the spiral seal continuous discharge filter of the present invention can be widely applied to treatment of waste liquid or sludge by supercritical water treatment process.

Furthermore, the two-stage spiral blades comprise in sequence from top to bottom the mixing blades for mixing filter residue and the spiral blades for sealing and pushing filter residue; wherein the mixing blades for mixing filter residue is for preventing that the filter residue is squeezed into blocks and difficult to move down. The spiral blades for sealing and pushing the filter residue is used for keeping a stable pressure in the chamber of the filter to push the filter residue out during the discharge process by sealing the filter residue.

These and other objectives, features, and advantages of the present invention will become apparent from the following detailed description, the accompanying drawings, and the appended claims.

### BRIEF DESCRIPTION OF THE DRAWINGS

The Figure is a structural schematic view of a spiral seal continuous discharge filter for supercritical water treatment process according to a preferred embodiment of the present invention.

1—motor; 2—liquid inlet; 3—filter screen; 4—electric scratch brushes; 5—purified liquid outlet; 6—mixing blades for mixing; 7—spiral blades for sealing and pushing filter residue; 8—vertical discharge pipe; 9—discharge opening.

### DETAILED DESCRIPTION OF THE PREFERRED EMBODIMENT

Further description of the present invention is illustrated combining with the preferred embodiments. One skilled in the art will understand that the embodiment of the present invention as shown in the drawings and described above is exemplary only and not intended to be limited.

Referring to the Figure, according to a preferred embodiment of the present invention, a spiral seal continuous discharge filter for supercritical water treatment process, comprising: a filter chamber and a motor 1 provided on a top of the filter chamber; wherein a liquid inlet 2 is provided on an up portion of a wall of the filter chamber, a filter screen 3 is provided in the filter chamber, a purified liquid outlet 5 is provided on an external side of the filter screen 3, wherein the filter chamber is in a cylindrical shape and the filter screen is also in a cylinder shape; the purified liquid outlet 5 is outside the filter screen which is in a cylinder shape; when liquid passes through the filter screen, solid matter in the liquid is trapped in the internal wall of the filter screen, and the purified liquid which is filtered is discharged via a purified liquid outlet.

A vertical discharge pipe 8 is provided on a bottom portion of the filter chamber, a driving rod rotated by driven of the motor 1 is provided on a central axis of the filter chamber, a plurality of electric scratch brushes 4 are provided on the driving rod, and a two-stage spiral blade unit is provided on a bottom of the driving rod.

The two-stage spiral blade unit comprises from top to bottom mixing blades 6 for mixing filter residue and a spiral blade 7 for sealing and pushing the filter residue. The mixing blades 6 for mixing the filter residue are provided in a tapering cavity on a bottom of the filter chamber; the spiral blade 7 for sealing and pushing the filter residue is provided in the vertical discharge pipe 8. A discharge opening 9 is welded on a bottom of the vertical discharge pipe 8.

### Embodiment 1

A spiral seal continuous discharge filter for supercritical water treatment process according to the Embodiment 1, comprises a conventional continuous filter, wherein a driving rod driven by a motor 1 is provided on a center of a filter chamber, electric scratch brushes 4 are provided on the driving rod. A vertical discharge pipe 8 is provided on a bottom of the filter chamber. The motor 1 drives the driving rod with the electric scratch brushes 4, two mixing blades 6 for mixing filter residue and four spiral blades 7 for sealing and pushing filter residue are provided in sequence from top to bottom on a low portion of the driving rod; wherein a diameter of the mixing blades 6 for mixing filter residue is greater than a diameter of the spiral blades 7 for sealing and pushing filter residue. A distance between a blade edge of the spiral blades 7 for sealing and pushing filter residue and an internal wall of the vertical discharge pipe is at a range of 0.15-1 mm. A discharge opening 9 is welded on a bottom of the vertical discharge pipe 8. During the filtering and discharging process, a pressure at the inlet keeps 0.4 MPa, and a pressure of an internal chamber inside the filter always maintains at approximately 0.2 MPa with a fluctuation value of not more than 5%.

### Embodiment 2

A spiral seal continuous discharge filter for supercritical water treatment process according to the Embodiment 1, comprises a conventional continuous filter, wherein a driving rod driven by a motor 1 is provided on a center of a filter chamber, electric scratch brushes 4 are provided on the driving rod. A vertical discharge pipe 8 is provided on a bottom of the filter chamber. The motor 1 drives the driving rod with the electric scratch brushes 4, four mixing blades 6 for mixing filter residue and four spiral blades 7 for sealing and pushing filter residue are provided in sequence from top to bottom on a low portion of the driving rod; wherein a diameter of the mixing blades 6 for mixing filter residue is greater than a diameter of the spiral blades 7 for sealing and pushing filter residue. A distance between a blade edge of the spiral blades 7 for sealing and pushing filter residue and an internal wall of the vertical discharge pipe is at a range of 0.15-1 mm. A discharge opening 9 is welded on a bottom of the vertical discharge pipe 8. During the filtering and discharging process, a pressure at the inlet keeps 0.4 MPa, and a pressure of an internal chamber inside the filter always maintains at approximately 0.2 MPa with a fluctuation value of not more than 5%.

### Embodiment 3

A spiral seal continuous discharge filter for supercritical water treatment process according to the Embodiment 1, comprises a conventional continuous filter, wherein a driving rod driven by a motor 1 is provided on a center of a filter chamber, electric scratch brushes 4 are provided on the driving rod. A vertical discharge pipe 8 is provided on a bottom of the filter chamber. The motor 1 drives the driving rod with the electric scratch brushes 4; four mixing blades 6 for mixing filter residue and six spiral blades 7 for sealing and pushing filter residue are provided in sequence from top to bottom on a low portion of the driving rod; wherein a diameter of the mixing blades 6 for mixing filter residue is greater than a diameter of the spiral blades 7 for sealing and pushing filter residue. A distance between a blade edge of the spiral blades 7 for sealing and pushing filter residue and an internal wall of the vertical discharge pipe is at a range of 0.15-1 mm. A discharge opening 9 is welded on a bottom of the vertical discharge pipe 8. During the filtering and discharging process, a pressure at the inlet keeps 0.4 MPa, and a pressure of an internal chamber inside the filter always maintains at approximately 0.2 MPa with a fluctuation value of not more than 5%.

The vertical discharge pipe 8 is vertically provided below the discharge opening of the continuous filter, due to the gravity and pressure the filter residue in the discharge pipe is easier to be discharged than the filter residue in horizontally provided discharge pipe. Providing the mixing blades 6 for mixing filter residue and the spiral blades 7 for sealing and pushing filter residue in sequence from top to bottom on a low portion of the driving rod is capable of preventing the phenomenon of agglomeration by squeezing. Meanwhile, by the spiral blades for sealing and pushing the filter residue to promote discharging the filter residue.

Detailed description of the present invention is illustrated by the three embodiments mentioned above. It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A spiral seal continuous discharge filter for supercritical water treatment process, comprising: a filter chamber and a motor (1) provided on a top of the filter chamber; wherein a liquid inlet (2) is provided on an up portion of a wall of the filter chamber, a filter screen (3) is provided in the filter chamber, a purified liquid outlet (5) is provided on an external side of the filter screen (3), a vertical discharge pipe (8) is provided on a bottom portion of the filter chamber, a driving rod rotated by driven of the motor (1) is provided on a central axis of the filter chamber, a plurality of electric scratch brushes (4) are provided on the driving rod, and a two-stage spiral blade unit is provided on a bottom of the driving rod.

2. The spiral seal continuous discharge filter for supercritical water treatment process, as recited in claim 1, wherein the two-stage spiral blade unit comprises from top to bottom mixing blades (6) for mixing filter residue and spiral blades (7) for sealing and pushing the filter residue.

3. The spiral seal continuous discharge filter for supercritical water treatment process, as recited in claim 1, wherein the mixing blades (6) for mixing the filter residue are provided in a tapering cavity on a bottom of the filter chamber; the spiral blades (7) for sealing and pushing the filter residue are provided in the vertical discharge pipe (8).

4. The spiral seal continuous discharge filter for supercritical water treatment process, as recited in claim 3, wherein a distance between the spiral blades (7) for sealing and pushing the filter residue and an internal wall of the vertical discharge pipe is 0.15-1 mm.

5. The spiral seal continuous discharge filter for supercritical water treatment process, as recited in claim 2, wherein a diameter of the mixing blades (6) for mixing the filter residue is greater than a diameter of the spiral blades (7) for sealing and pushing the filter residue.

6. The spiral seal continuous discharge filter for supercritical water treatment process, as recited in claim 2, wherein an amount of the mixing blades (6) for mixing the filter residue is at a range of 6-8.

7. The spiral seal continuous discharge filter for supercritical water treatment process, as recited in claim 2, wherein an amount of the spiral blades (7) for sealing and pushing the filter residue is at a range of 2-10.

8. The spiral seal continuous discharge filter for supercritical water treatment process, as recited in claim 2, wherein a discharge opening (9) is welded on a bottom of the vertical discharge pipe (8).
